(19) United States
(12) Patent Application Publication
(10) Pub. No.: US 2019/0245181 A1
(43) Pub. Date: Aug. 8, 2019

(54) SEPARATOR AND SECONDARY BATTERY INCLUDING THE SEPARATOR

(71) Applicant: Sumitomo Chemical Company, Limited, Tokyo (JP)

(72) Inventors: Chikae YOSHIMARU, Osaka-shi, Osaka (JP); Chikara MURAKAMI, Osaka-shi, Osaka (JP); Junji SUZUKI, Niihama-shi, Ehime (JP)

(21) Appl. No.: 16/344,094

(22) PCT Filed: Oct. 24, 2016
(86) PCT No.: PCT/JP2016/081479

§ 371 Date: Apr. 23, 2019

(51) Int. Cl. H01M 2/16; C08L 23/06; C08J 9/26

(52) U.S. Cl. CPC H01M 2/1653; H01M 2/1686; C08L 23/06; C08J 9/26; C08J 2491/06; C08L 2201/08; C08L 2203/20; C08J 2201/0444; C08J 2323/06; C08L 2207/068

(57) ABSTRACT

Provided is a separator including a separator which consists of a porous polyolefin of 95 wt % or more and an organic additive. A temperature-increase convergence time of the first layer is equal to or longer than 2.9 s·m²/g and equal to or shorter than 5.7 s·m²/g when the first layer is irradiated with a microwave having a frequency of 2455 MHz and an output power of 1800 W after dipping the first layer in N-methylpyrrolidone containing 3 wt % of water, whereas a white index is equal to or more than 86 and equal to or less than 98.

### FIELD

An embodiment of the present invention relates to a separator and a secondary battery including the separator. For example, an embodiment of the present invention relates to a separator capable of being used in a nonaqueous electrolyte-solution secondary battery and a nonaqueous electrolyte-solution secondary battery including the separator.

### BACKGROUND

As a typical example of a nonaqueous electrolyte-solution secondary battery, a lithium ion secondary battery is represented. Since a lithium-ion secondary battery has a high energy density, it has been widely used in electronic devices such as a personal computer, a mobile phone, and a mobile information terminal. A lithium ion secondary battery includes a positive electrode, a negative electrode, an electrolyte solution charged between the positive electrode and the negative electrode, and a separator. The separator separates the positive electrode and the negative electrode from each other and also functions as a film transmitting the electrolyte solution and carrier ions. For example, patent literature 1 to 5 disclose a separator including a polyolefin.

### CITATION LIST

### Patent Literature

Patent Literature 1: Japanese Patent No. 5164296
Patent Literature 2: Japanese Patent Application Publication No. 2015-120835
Patent Literature 3: Japanese Patent Application Publication No. 2014-56843
Patent Literature 4: Japanese Patent Application Publication No. 2015-60686
Patent Literature 5: Japanese Patent Application Publication No. 2013-73737

### SUMMARY

An object of the present invention is to provide a separator capable of being used in a secondary battery such as a nonaqueous electrolyte-solution secondary battery and a secondary battery including the separator. Alternatively, an object of the present invention is to provide a separator capable of suppressing a reduction in a rate property when a secondary battery is repeatedly charged and discharged as well as a secondary battery including the separator.

An embodiment of the present invention is a separator including a first layer which consists of a porous polyolefin. A temperature-increase convergence time of the first layer is equal to or longer than 2.9 s·m²/g and equal to or shorter than 5.7 s·m²/g when the first layer is irradiated with a microwave having a frequency of 2455 MHz and an output power of 1800 W after dipping the first layer in N-methylpyrrolidone containing 3 wt % of water, and a white index of the first layer is equal to or more than 86 and equal to or less than 98.

### Effects of Invention

According to the present invention, it is possible to provide a separator capable of producing a secondary battery which can exhibit an excellent rate property even after repeating charging and discharging and to provide a second battery, such as a nonaqueous electrolyte-solution secondary battery, including the separator.

### BRIEF DESCRIPTION OF DRAWINGS

FIG. 1A and FIG. 1B are respectively schematic cross-sectional views of a secondary battery and a separator according to an embodiment of the present invention.

### DESCRIPTION OF EMBODIMENTS

Hereinafter, the embodiments of the present invention are explained with reference to the drawings and the like. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention.

In the specification and the claims, unless specifically stated, when a state is expressed where a structure is arranged “on” another structure, such an expression includes both a case where the substrate is arranged immediately above the “other structure” so as to be in contact with the “other structure” and a case where the structure is arranged over the “other structure” with an additional structure therebetween.

In the specification and the claims, an expression “substantially including only A” includes a state where no substance is included other than A, a state where A and an impurity are included, and a state misidentified as a state where a substance other than A is included due to a measurement error. When this expression means the state where A and an impurity are included, there is no limitation to the kind and concentration of the impurity.

### First Embodiment

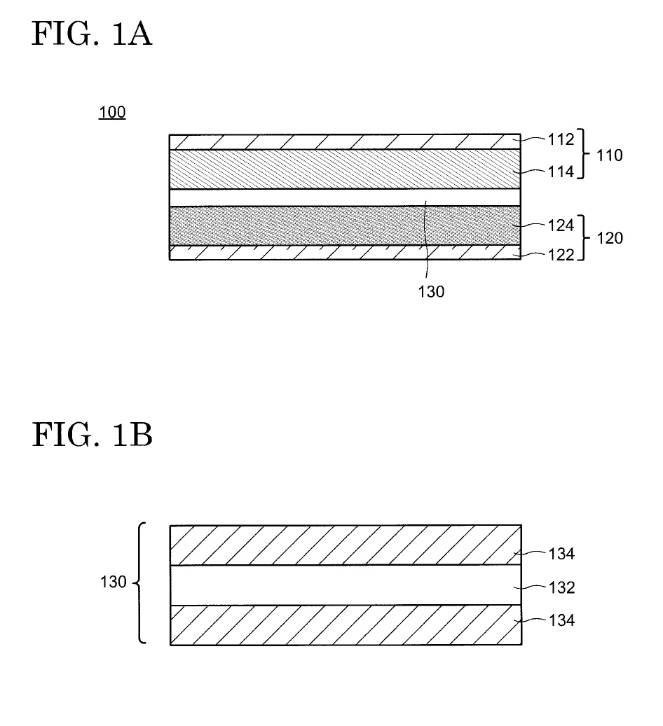

A schematic cross-sectional view of a secondary battery 100 according to an embodiment of the present invention is shown in FIG. 1A. The secondary battery 100 includes a positive electrode 110, a negative electrode 120, and a separator 130 separating the positive electrode 110 and the negative electrode 120 from each other. Although not illustrated, the secondary battery 100 possesses an electrolyte solution 140. The electrolyte solution 140 mainly exists in apertures of the positive electrode 110, the negative electrode 120, and the separator 130 as well as in the gaps between these members. The positive electrode 110 may include a positive-electrode current collector 112 and a positive-electrode active-substance layer 114. Similarly, the negative electrode 120 may include a negative-electrode current collector 122 and a negative-electrode active-substance layer 124. Although not illustrated in FIG. 1A, the secondary battery 100 further possesses a housing by which the positive electrode 110, the negative electrode 120, the separator 130, and the electrolyte solution 140 are supported.

### 1. Separator

### 1-1. Structure

The separator 130 is disposed between the positive electrode 110 and the negative electrode 120 and serves as a film having a role of separating the positive electrode 110 and the negative electrode 120 and transporting the electrolyte solution 140 in the secondary battery 100. A schematic cross-sectional view of the separator 130 is shown in FIG. 1B. The separator 130 has a first layer 132 including a porous polyolefin and may further possess a porous layer 134 as an optional structure. The separator 130 may have a structure in which two porous layers 134 sandwich the first layer 132 as shown in FIG. 1B, or a structure in which the porous layer 134 is disposed only on one surface of the first layer 132. Alternatively, a structure may be employed where no porous layer 134 is provided. The first layer 132 may have a single-layer structure or may be structured with a plurality of layers.

The first layer 132 has internal pores linked to each other. This structure allows the electrolyte solution 140 to permeate the first layer 132 and enables carrier ions such as lithium ions to be transported via the electrolyte solution 140. At the same time, physical contact between the positive electrode 110 and the negative electrode 120 is inhibited. On the other hand, when the secondary battery 100 has a high temperature, the first layer 132 melts and the pores disappear, thereby stopping the transportation of the carrier ions. This behavior is called shutdown. This behavior prevents heat generation and ignition caused by a short-circuit between the positive electrode 110 and the negative electrode 120, by which high safety is secured.

The first layer 132 may be composed of a porous polyolefin. Namely, the first layer 132 may be configured so as to include only a porous polyolefin or substantially include only a porous polyolefin. Alternatively, the first layer 132 may include a porous polyolefin and an additive. In this case, the first layer 132 may be composed of only with the porous polyolefin and the additive or substantially only with the porous polyolefin and the additive. When the porous polyolefin and an organic additive are included, the polyolefin may be included in the porous polyolefin at a composition equal to or higher than 95 wt %, equal to or higher than 97 wt %, or equal to or higher than 99%. Furthermore, the polyolefin may be included in the first layer 132 at a composition equal to or higher than 95 wt %, equal to or higher than 97 wt %, or equal to or higher than 99 wt %. A content of the polyolefin included in the porous film may be 100 wt % or equal to or less than 100 wt %. As the additive, an organic compound (organic additive) is represented, and the organic compound may be an antioxidant (organic antioxidant) or a lubricant.

As the polyolefin structuring the porous polyolefin, a homopolymer obtained by polymerizing an α-olefin such as ethylene, propylene, 1-butene, 4-methyl-1-pentene, and 1-hexene or a copolymer thereof is represented. A mixture of these homopolymers and copolymers may be included in the first layer 132. The organic additive may have a function to prevent oxidation of the polyolefin, and phenols or phosphoric esters may be employed as the organic additive, for example. Phenols having a bulky substituent such as a t-butyl group at an α-position and/or a β-position of a phenolic hydroxy group may be also used.

As a typical polyolefin, a polyethylene-based polymer is represented. When a polyethylene-based polymer is used, a low-density polyethylene or a high-density polyethylene may be used. Alternatively, a copolymer of ethylene with an α-olefin may be used. These polymers or copolymers may be a high-molecular weight polymer with a weight-average molecular weight equal to or higher than 100,000 or an ultrahigh-molecular weight polymer with a weight-average molecular weight of equal to or higher than 1,000,000. The use of a polyethylene-based polymer enables the shutdown function to be realized at a lower temperature, thereby providing high safety to the secondary battery 100. Moreover, mechanical strength of the separator can be increased by using an ultrahigh-molecular weight polymer with a weight-average molecular weight of equal to or higher than 1,000,000.

A thickness of the first layer 132 is appropriately determined in view of thicknesses of other members in the secondary battery 100 and may be equal to or larger than 4 μm and equal to or smaller than 40 μm, equal to or larger than 5 μm and equal to or smaller than 30 μm, or equal to or larger than 6 μm and equal to or smaller than 15 μm.

A weight per unit area of the first layer 132 is appropriately determined in view of its strength, thickness, weight, and handleability. For example, the weight per unit area may be equal to or more than 4 g/m² and equal to or less than 20 g/m², equal to or more than 4 g/m² and equal to or less than 12 g/m², or equal to or more than 5 g/m² and equal to or less than 10 g/m², by which a weight-energy density and a volume-energy density of the secondary battery 100 can be increased. Note that a weight per unit area is a weight per unit area.

With respect to gas permeability of the first layer 132, its Gurley value may be selected from a range equal to or higher than 30 s/100 mL and equal to or lower than 500 s/100 mL or equal to or higher than 50 s/100 mL and equal to or lower than 300 s/100 mL so that sufficient ion-permeability can be obtained.

A porosity of the first layer 132 may be selected from a range equal to or more than 20 vol % and equal to or less than 80 vol % or equal to or more than 30 vol % and equal to or less than 75 vol % so that a retention volume of the electrolyte solution 140 is increased and the shutdown function is surely realized. A diameter of the pore (average pore diameter) in the first layer 132 may be selected from a range equal to or larger than 0.01 μm and equal to or smaller than 0.3 μm or equal to or larger than 0.01 μm and equal to or smaller than 0.14 μm so that a sufficient ion-permeability and a high shutdown function can be obtained.

### 1-2. Property

A time per the weight per unit area of the first layer 132, which is required to converge a temperature increase caused by irradiating the first layer 132 with a microwave having a frequency of 2455 Hz and an output power of 1800 W after being dipped in N-methylpyrrolidone containing 3 wt % of water (hereinafter referred to as a temperature-increase convergence time), is equal to or longer than 2.9 s·m²/g and equal to or shorter than 5.7 s·m²/g or equal to or longer than 2.9 s·m²/g and equal to or shorter than 5.3 s·m²/g. Moreover, a white index of the first layer is equal to or more than 86 and equal to or less than 98 or equal to or more than 90 and equal to or less than 97.

In the present specification and the claims, the WI is the WI regulated by the American Standards Test Methods E313. The WI can be measured using an optical measurement apparatus such as an integrating-sphere spectrophotometer.

The structure of the pores in the first layer 132 (capillary attraction in the pores and an area of the pore wall) and an ability to supply the electrolyte solution 140 from the first layer 132 to the electrodes (the positive electrode 110 and the negative electrode 120) relate to a decrease in the rate property when charging/discharging of the battery is repeated or the battery is operated at a large current. For example, the charging/discharging of the secondary battery 100 results in expansion of the electrodes. Specifically, the negative electrode expands during charging, while the positive electrode expands during discharging. Therefore, the electrolyte solution 140 included in the first layer 132 is extruded from the side of the expanding electrode to the side of the opposing to electrode. The electrolyte solution 140 moves in the pores of the first layer 132 during charging/discharging due to this mechanism.

When the electrolyte solution 140 moves in the pores of the first layer 132, the wall surface of the pores receives a pressure from the electrolyte solution 140. The magnitude of the pressure relates to the structure of the pores. Specifically, it is considered that the pressure received by the wall surface of the pores increases with increasing capillary attraction and increasing area of the wall surface of the pores. In addition, the magnitude of the pressure also relates to the amount of the electrolyte solution 140 moving in the pores and increases when the amount of the moving electrolyte solution 140 is increased, that is, when the secondary battery 100 is operated at a large current. An increase in pressure causes deformation of the wall surface so as to close the pores by the pressure, which results in a reduction in battery-output property. Therefore, the rate property gradually decreases by repeating charging/discharging of the secondary battery 100 or by operating the secondary battery 100 at a large current.

On the other hand, when the amount of the electrolyte solution 140 permeating the first layer 132 is small, the electrolyte solution 140 at a vicinity of the electrodes may be decreased, and the electrolyte solution 140 may decompose. Products resulting from decomposition of the electrolyte solution 140 lead to a reduction in rate property of the secondary battery 100.

Here, when water-containing N-methylpyrrolidone is irradiated to with a microwave, heat generates due to the vibration energy of water. The generated heat is conducted to the first layer 132 which is in contact with N-methylpyrrolidone. The increase in temperature of N-methylpyrrolidone converges when the heat-generating rate and a heat-radiating rate due to the heat conduction to the first layer 132 reach an equilibrium. Thus, the time required to converge the temperature increase (temperature-increase convergence time) relates to a degree of contact between the solvent included in the first layer 132 (here, the water-containing N-methylpyrrolidone) and the first layer 132. Since the degree of contact closely relates to the capillary attraction in the pores and the area of the wall surface of the pores of the first layer 132, it is possible to evaluate the structure of the pores using the temperature-increase convergence time. Specifically, a short temperature-increase convergence time indicates large capillary attraction in the pores and a large area of the wall of the pores.

In addition, the degree of contact is considered to increase with increasing movability of the electrolyte solution 140 in the pores of the first layer 132. Hence, it is possible to evaluate the ability to supply the electrolyte solution 140 from the first layer 132 to the positive electrode 110 and the negative electrode 120. Specifically, the ability to supply the electrolyte solution 140 increases with decreasing temperature-increase convergence time.

In the case where the temperature-increase convergence time of the first layer 132 is shorter than 2.9 s·m²/g, the capillary attraction in the pores is too high and the area of the wall of the pores of the first layer 132 is too large, which leads to an increase in pressure applied to the wall of the pores by the electrolyte solution 140 moving in the pores during a charging/discharging cycle or during operation at a large current and results in the closing of the pores.

On the other hand, in the case where the temperature-increase convergence time exceeds 5.7 s·m²/g, the solvent cannot readily move in the pores of the first layer 132, and the moving rate of the electrolyte solution decreases at a vicinity of the electrodes, which causes a reduction in rate property of the battery. As a result, the internal resistance of the secondary battery 100 increases, the rate property reduces after repeating charging/discharging, and the output property diminishes.

The WI is an index indicating hue (whiteness), and a high WI means a high whiteness. A decrease in WI (i.e., low whiteness) suggests an increase in the number of functional groups such as a carboxyl group at the surface or in the first layer 132. Since a polar functional group such as a carboxyl group inhibits permeation of carrier ions (that is, permeability is reduced), it is considered that the rate property of the secondary battery 100 decreases with decreasing WI.

In the case where the WI of the first layer 132 is equal to or more than 86 and equal to or less than 98, the amount of functional groups included at the surface and in the first layer 132 is suitable for maintaining the carrier-ion permeability. Hence, it is possible to adjust the carrier-ion permeability of the first layer 132 within a suitable range. As a result, the use of the first layer 132 having the WI falling within the aforementioned range prevents a reduction in rate property of the secondary battery, by which an excellent rate property can be realized even if charging/discharging is repeated. The WI of the first layer 132 is preferably equal to or more than 90 and equal to or less than 97.

On the other hand, when the WI of the first layer 132 is equal to or higher than 86, the carrier-ion permeability of the first layer 132 is high because the amount of functional groups at the surface and in the first layer 132 is small. Accordingly, it is possible to suppress a reduction in rate property.

When the WI of the first layer 132 exceeds 98, transportation of the carrier ions is inhibited because the amount of the functional groups at the surface and in the first layer 132 is too small and the affinity of the first layer 132 to the electrolyte solution 140 is reduced.

Therefore, the use of the separator 130 including the first layer 132 satisfying the aforementioned parameters allows production of the secondary battery 100 capable of realizing an excellent rate property even when charging/discharging is repeated.

### 2. Electrode

As described above, the positive electrode 110 may include the positive-electrode current collector 112 and the positive-electrode active-substance layer 114. Similarly, the negative electrode 120 may include the negative-electrode current collector 122 and the negative-electrode active-substance layer 124 (see FIG. 1A). The positive-electrode current collector 112 and the negative-electrode current collector 122 respectively possess the positive-electrode active-substance layer 114 and the negative-electrode active-substance layer 124 and have functions to supply current to the positive-electrode active-substance layer 114 and the negative-electrode active-substance layer 124, respectively.

A metal such as nickel, copper, titanium, tantalum, zinc, iron, and cobalt or an alloy such as stainless steel including these metals can be used for the positive-electrode current collector 112 and the negative-electrode current collector 122, for example. The positive-electrode current collector 112 and the negative-electrode current collector 122 may have a structure in which a plurality of layers including these metals is stacked.

The positive-electrode active-substance layer 114 and the negative-electrode active-substance layer 124 respectively include a positive-electrode active substance and a negative-electrode active substance. The positive-electrode active substance and the negative-electrode active substance have a role to release and absorb carrier ions such as lithium ions.

As a positive-electrode active substance, a material capable of being doped or de-doped with carrier ions is represented, for example. Specifically, a lithium-based composite oxide containing at least one kind of transition metals such as vanadium, manganese, iron, cobalt, and nickel is represented. As such a composite oxide, a lithium-based composite oxide having an α-NaFeO₂-type structure, such as lithium nickelate and lithium cobaltate, and a lithium-based composite oxide having a spinel-type structure, such as lithium manganese spinel, are given. These composite oxides have a high average discharge potential.

The lithium-based composite oxide may contain another metal element and is exemplified by lithium nickelate (composite lithium nickelate) including an element selected from titanium, zirconium, cerium, yttrium, vanadium, chromium, manganese, iron, cobalt, copper, silver, magnesium, aluminum, gallium, indium, tin, and the like, for example. These metals may be adjusted to be equal to or more than 0.1 mol % and equal to or less than 20 mol % to the metal elements in the composite lithium nickelate. This structure provides the secondary battery 100 with excellent cycle characteristics when used at a high capacity. For example, a composite lithium nickelate including aluminum or manganese and containing nickel at 85 mol % or more or 90 mol % or more may be used as the positive-electrode active substance.

Similar to the positive-electrode active substance, a material capable of being doped and de-doped with carrier ions can be used as the negative-electrode active substance. For example, a lithium metal or a lithium alloy is represented. Alternatively, it is possible to use a carbon-based material such as graphite exemplified by natural graphite and artificial graphite, cokes, carbon black, and a sintered polymeric compound exemplified by carbon fiber; a chalcogen-based compound capable of being doped and de-doped with lithium ions at a potential lower than that of the positive electrode, such as an oxide and a sulfide; an element capable of being alloyed or reacting with an alkaline metal, such as aluminum, lead, tin, bismuth, and silicon; an intermetallic compound of cubic system (AlSb, Mg₂Si, NiSi₂) undergoing alkaline-metal insertion between lattices; lithium-nitride compound (Li₃₋ₓMₓN (M: transition metal)); and the like. Among the negative-electrode active substances, the carbon-based material including graphite such as natural graphite and artificial graphite as a main component provides a large energy density due to high potential uniformity and a low average discharge potential when combined with the positive electrode 110. For example, it is possible to use, as the negative-electrode active substance, a mixture of graphite and silicon with a ratio of silicon to carbon equal to or larger than 5 mol % and equal to or smaller 10 mol %.

The positive-electrode active-substance layer 114 and the negative-electrode active-substance layer 124 may each further include a conductive additive and binder other than the aforementioned positive-electrode active substance and the negative-electrode active substance.

As a conductive additive, a carbon-based material is represented. Specifically, graphite such as natural graphite and artificial graphite, cokes, carbon black, pyrolytic carbons, and a sintered polymeric compound such as carbon fiber are given. A plurality of materials described above may be mixed to use as a conductive additive.

As a binder, poly(vinylidene fluoride) (PVDF), polytetrafluoroethylene, poly(vinylidene fluoride-co-hexafluoropropylene), poly(tetrafluoroethylene-co-hexafluoropropylene), poly(tetrafluoroethylene-co-perfluoroalkyl vinyl ether), poly(ethylene-co-tetrafluoroethylene), a copolymer in which vinylidene fluoride is used as a monomer, such as a poly(vinylidene fluoride-co-hexafluoropropylene-co-tetrafluoroethylene), a thermoplastic resin such as a thermoplastic polyimide, polyethylene, and polypropylene, an acrylic resin, styrene-butadiene rubber, and the like are represented. Note that a binder may further have a function as a thickener.

The positive electrode 110 may be formed by applying a mixture of the positive-electrode active substance, the conductive additive, and the binder on the positive-electrode current collector 112, for example. In this case, a solvent may be used to form or apply the mixture. Alternatively, the positive electrode 110 may be formed by applying a pressure to the mixture of the positive-electrode active substance, the conductive additive, and the binder to process the mixture and arranging the processed mixture on the positive electrode 110. The negative electrode 120 can also be formed with a similar method.

### 3. Electrolyte Solution

The electrolyte solution 140 includes the solvent and an electrolyte, and at least a part of the electrolyte is dissolved in the solvent and electrically dissociated. As the solvent, water and an organic solvent can be used. In the case where the secondary battery 100 is utilized as a nonaqueous electrolyte-solution secondary battery, an organic solvent is used. As an organic solvent, carbonates such as ethylene carbonate, propylene carbonate, dimethyl carbonate, diethyl carbonate, ethyl methyl carbonate, and 1,2-di(methoxycarbonyloxy)ethane, ethers such as 1,2-dimethoxyethane, 1,3-dimethoxypropane, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone, sulfur-containing compounds such as sulfolane, dimethyl sulfoxide, and 1,3-propanesultone; a fluorine-containing organic solvent in which fluorine is introduced to the aforementioned organic solvent; and the like are represented. A mixed solvent of these organic solvents may also be employed.

As a typical electrolyte, a lithium salt is represented. For example, LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, a lithium salt of a carboxylic acid having 2 to 6 carbon atoms, LiAlCl₄, and the like are represented. Just one kind of the lithium salts mentioned above may be used, and more than two kinds of lithium salts may be combined.

Note that, in a broad sense, an electrolyte may mean a solution of an electrolyte. However, in the present specification and claims, a narrow sense is employed. That is, an electrolyte is a solid and is electrically dissociated upon dissolving in a solvent to provide an ion conductivity to the resulting solution.

### 4. Fabrication Process of Secondary Battery

As shown in FIG. 1A, the negative electrode 120, the separator 130, and the positive electrode 110 are arranged to form a stacked body. After that, the stacked body is disposed in a housing which is not illustrated. The secondary battery 100 can be fabricated by filling the housing with the electrolyte solution and sealing the housing while reducing a pressure in the housing or by sealing the housing after filing the housing with the electrolyte solution while reducing a pressure in the housing. A shape of the secondary battery 100 is not limited and may be a thin-plate (paper) form, a disc form, a cylinder form, a prism form such as a rectangular parallelepiped, or the like.

The separator 130 according to the present embodiment possesses the first layer 132 containing a porous polyolefin, and the first layer 132 satisfies the aforementioned ranges of the temperature-increase convergence time and the WI. The second battery 100 is installed with the separator 130 including the first layer 132 satisfying these properties. Hence, a reduction in rate property of the secondary battery 100 is small, which means that the secondary battery 100 exhibits an excellent ability to maintain the rate property.

### Second Embodiment

In the present embodiment, a method for preparing the first layer 132 described in the First Embodiment is described. An explanation of the structures the same as those of the First Embodiment may be omitted.

A method for preparing the first layer 132 includes (1) a process for obtaining a polyolefin composite by kneading an ultrahigh-molecular weight polyethylene, a low-molecular weight polyolefin having a weight-average molecular weight equal to or less than 10,000, and a pore-forming agent, (2) a process for forming a sheet by rolling the polyolefin composite with a rolling roll (rolling process), (3) a process for removing the pore-forming agent from the sheet obtained in the process (2), and (4) a process for processing into a film state by stretching the sheet obtained in the process (3). The order of the process (3) and the process (4) may be interchanged.

The pore-forming agent used in the process (1) may include an organic substance or an inorganic substance. As an organic substance, a plasticizer is represented which is exemplified by a low-molecular weight hydrocarbon such as a liquid paraffin.

As an inorganic substance, an inorganic material soluble in a neutral, acidic, or alkaline solvent is represented, and calcium carbonate, magnesium carbonate, barium carbonate, and the like are exemplified. Other than these materials, an inorganic compound such as calcium chloride, sodium chloride, and magnesium sulfate is represented.

At this time, the use of a pore-forming agent having a BET (Brunauer-Emmett-Teller) specific surface area equal to or larger than 6 m²/g and equal to or smaller than 16 m²/g, equal to or larger than 8 m²/g and equal to or smaller than 15 m²/g, or equal to or larger than 10 m²/g and equal to or smaller than 13 m²/g increases dispersibility of the pore-forming agent and prevents local oxidation of the first layer 132 when processing. Thus, formation of a functional group such as a carboxylic group in the first layer 132 is prevented, and pores having a small average pore diameter can be uniformly distributed. As a result, the first layer 132 with the WI equal to or more than 85 and equal to or less than 98 can be obtained.

In the process (3) in which the pore-forming agent is removed, a solution of water or organic solvent to which an acid or a base is added, or the like is used as a cleaning solution. A surfactant may be added to the cleaning solution. An addition amount of the surfactant can be arbitrarily selected from a range equal to or more than 0.1 wt % to 15 wt % or equal to or more than 0.1 wt % and equal to or less than 10 wt %. It is possible to secure a high cleaning efficiency and prevent the surfactant from being left by selecting the addition amount from this range. A cleaning temperature may be selected from a temperature range equal to or higher than 25° C. and equal to or lower than 60° C., equal to or higher than 30° C. and equal to or lower than 55° C., or equal to or higher than 35° C. and equal to or lower than 50° C., by which a high cleaning efficiency can be obtained and evaporation of the cleaning solution can be avoided.

In the process (3), water cleaning may be further conducted after removing the pore-forming agent with the cleaning solution. The temperature in the water cleaning may be selected from a temperature range equal to or higher than 25° C. and equal to or lower than 60° C., equal to or higher than 30° C. and equal to or lower than 55° C., or equal to or higher than 35° C. and equal to or lower than 50° C.

The pore structure of the first layer 132 is also influenced by the deforming rate at the stretching in the process (4) as well as the temperature of the thermal fixation treatment (annealing treatment), performed on the stretched film, per unit thickness of the stretched film (a thermal fixation temperature per unit thickness of the stretched film, which is, hereinafter, referred to as a thermal fixation temperature). Therefore, the structure of the pores in the first layer 132 can be controlled, and the range of the temperature-increase convergence time described in the First Embodiment can be obtained by adjusting the deforming rate and the thermal fixation temperature.

Specifically, it is possible to obtain the first layer 132 by adjusting the stretching rate and the thermal fixation temperature within a range of a triangle having three vertexes of (500%/min, 1.5° C./μm), (900%/min, 14.0° C./μm), and (2500%/min, 11.0° C./μm) or a triangle having three vertexes of (600%/min, 5.0° C./μm), (900%/min, 12.5° C./μm), and (2500%/min, 11.0° C./μm).

### Third Embodiment

In the present embodiment, an embodiment in which the separator 130 has the porous layer 134 in addition to the first layer 132 is explained.

### 1. Structure

As described in the First Embodiment, the porous layer 134 may be disposed on one side or both sides of the first layer 132 (see FIG. 1B). When the porous layer 134 is stacked on one side of the first layer 132, the porous layer 134 may be arranged on a side of the positive electrode 110 or on a side of the negative electrode 120 of the first layer 132.

The porous layer 134 is insoluble in the electrolyte solution 140 and is preferred to include a material chemically stable in a usage range of the second battery 100. As such a material, it is possible to represent a polyolefin such as polyethylene, polypropylene, polybutene, poly(ethylene-co-propylene); a fluorine-containing polymer such as poly(vinylidene fluoride) (PVDF), polytetrafluoroethylene, poly(vinylidene fluoride-co-hexafluoropropylene), and poly(tetrafluoroethylene-co-hexafluoropropylene); an aromatic polyamide (aramide); rubber such as poly(styrene-co-butadiene) and a hydride thereof, a copolymer of methacrylic esters, a poly(acrylonitrile-co-acrylic ester), a poly(styrene-co-acrylic ester), ethylene-propylene rubber, and poly(vinyl acetate); a polymer having a melting point and a glass-transition temperature of 180° C. or more, such as poly(phenylene ether), a polysulfone, a poly(ether sulfone), polyphenylenesulfide, a poly(ether imide), a polyamide-imide, a polyether-amide, and a polyester; a water-soluble polymer such as poly(vinyl alcohol), poly(ethylene glycol), a cellulose ether, sodium alginate, poly(acrylic acid), polyacrylamide, poly(methacrylic acid); and the like.

As an aromatic polyamide, poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylenecarboxylic amide), poly(metaphenylene-4,4′-biphenylenecarboxilic amide), poly(paraphenylene-2,6-natphthalenedicarboxlic amide), poly(metaphenylene-2,6-natphthalenedicarboxlic amide), poly(2-chloroparaphenylene terephthalamide), a copolymer of paraphenylene terephthalamide with 2,6-dichloroparaphenylene terephthalamide, a copolymer of metaphenylene terephthalamide with 2,6-dichloroparaphenylene terephthalamide, and the like are represented, for example.

The porous layer 134 may include a filler. A filler consisting of an organic substance or an inorganic substance is represented as a filler. A filler called a filling agent and consisting of an inorganic substance is preferred. A filler consisting of an inorganic oxide such as silica, calcium oxide, magnesium oxide, titanium oxide, alumina, mica, zeolite, aluminum hydroxide, boehmite, and the like is more preferred, at least one kind of filler selected from a group consisting of silica, magnesium oxide, titanium oxide, aluminum hydroxide, boehmite, and alumina is further preferred, and alumina is especially preferred. Alumina has a number of crystal forms such as α-alumina, β-alumina, γ-alumina, θ-alumina, and the like, and any of the crystal forms can be appropriately used. Among them, α-alumina is most preferable due to its particularly high thermal stability and chemical stability. Just one kind of filler may be used, or two or more kinds of filler may be combined in the porous layer 134.

No limitation is provided to a shape of the filler, and the filler may have a sphere shape, a cylindrical shape, an elliptical shape, a gourd shape, and the like. Alternatively, a filler in which these shapes are mixed may be used.

When the porous layer 134 includes the filler, an amount of the filler to be included may be equal to or larger than 1 vol % and equal to or smaller than 99 vol % or equal to or larger than 5 vol % and equal to or smaller than 95 vol % with respect to the porous layer 134. The aforementioned range of the amount of the filler to be included prevents the space formed by contact between the fillers from being closed by the material of the porous layer 134, which leads to sufficient ion permeability and allows its weight per unit area to be adjusted.

A thickness of the porous layer 134 can be selected from a range equal to or larger than 0.5 μm and equal to or smaller than 15 μm or equal to or larger than 2 μm and equal to or smaller than 10 μm. Hence, when the porous layers 134 are formed on both sides of the first layer 132, a total thickness of the porous layers 134 may be selected from a range equal to or larger than 1.0 μm and equal to or smaller than 30 μm or equal to or larger than 4 μm and equal to or smaller than 20 μm.

When the total thickness of the porous layers 134 is arranged to be equal to or larger than 1.0 μm, internal short-circuits caused by damage to the secondary battery 100 can be more effectively prevented. The total thickness of the porous layers 134 equal to or smaller than 30 μm prevents an increase in permeation resistance of the carrier ions, thereby preventing deterioration of the positive electrode 110 and a decrease in rate property and cycle property resulting from an increase in permeation resistance of the carrier ions. Moreover, it is possible to avoid an increase in distance between the positive electrode 110 and the negative electrode 120, which contributes to miniaturization of the secondary battery 100.

The weight per unit area of the porous layer 134 may be selected from a range equal to or more than 1 g/m² and equal to or less than 20 g/m² or equal to or more than 2 g/m² and equal to or less than 10 g/m². This range increases an energy density per weight and energy density per volume of the secondary battery 100.

A porosity of the porous layer 134 may be equal to or more than 20 vol % and equal to or less than 90 vol % or equal to or more than 30 vol % and equal to or less than 80 vol %. This range allows the porous layer 134 to have sufficient ion permeability. An average porous diameter of the pores included in the porous layer 134 may be selected from a range equal to or larger than 0.01 μm and equal to or smaller than 1 μm or equal to or larger than 0.01 μm and equal to or smaller than 0.5 μm, by which a sufficient ion permeability is provided to the secondary battery 100 and the shutdown function can be improved.

A gas permeability of the separator 130 including the aforementioned first layer 132 and the porous layer 134 may be equal to or higher than 30 s/100 mL and equal to or lower than 1000 s/100 mL or equal to or higher than 50 s/100 mL and equal to or lower than 800 s/100 L in a Gurley value, which enables the separator 130 to have sufficient strength, maintain a high shape stability at a high temperature, and possess sufficient ion permeability.

### 2. Preparation Method

When the porous layer 134 including the filler is prepared, the aforementioned polymer or resin is dissolved or dispersed in a solvent, and then the filler is dispersed in this mixed liquid to form a dispersion (hereinafter, referred to as a coating liquid). As a solvent, water; an alcohol such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, N,N-dimethylformamide; and the like are represented. Just one kind of solvent may be used, or two or more kinds of solvents may be used.

When the coating liquid is prepared by dispersing the filler to the mixed liquid, a mechanical stirring method, an ultrasonic dispersing method, a high-pressure dispersion method, a media dispersion method, and the like may be applied. In addition, after the filler is dispersed in the mixed liquid, the filler may be subjected to wet milling by using a wet-milling apparatus.

An additive such as a dispersant, a plasticizer, a surfactant, or a pH-adjusting agent may be added to the coating liquid.

After the preparation of the coating liquid, the coating liquid is applied on the first layer 132. For example, the porous layer 134 can be formed over the first layer 132 by directly coating the first layer 132 with the coating liquid by using a dip-coating method, a spin-coating method, a printing method, a spraying method, or the like and then removing the solvent. Instead of directly applying the coating liquid over the first layer 132, the porous layer 134 may be transferred onto the first layer 132 after being formed on another supporting member. As a supporting member, a film made of a resin, a belt or drum made of a metal may be used.

Any method selected from natural drying, fan drying, heat drying, and vacuum drying may be used to remove the solvent. Drying may be conducted after substituting the solvent with another solvent (e.g., a solvent with a low boiling point). When heating, drying may be carried out at 10° C. or higher and 120° C. or lower or at 20° C. or higher and 80° C. or lower. This temperature range avoids a reduction in gas permeability caused by shrinkage of the pores in the first layer 132.

A thickness of the porous layer 134 can be controlled by a thickness of the coating film in a wet state after coating, an amount of the filler included, a concentration of the polymer and the resin, and the like.

### EXAMPLES

### 1. Preparation of Separator

An example for preparing the separator 130 is described below.

### 1-1. Example 1

To a mixture of 70 wt % of ultrahigh-molecular weight polyethylene powder (GUR4032 manufactured by Ticona) and 30 wt % of polyethylene wax (FNP-0115, manufactured by Nippon Seiro Co. Ltd.) having a weight-average molecular weight of 1000 as well as 0.4 weight portions of an antioxidant (Irg1010, manufactured by CIBA Speciality Chemicals), 0.1 weight portions of an antioxidant (P168 manufactured by CIBA Speciality Chemicals.®), and 1.3 weight portions of sodium stearate with respect to 100 weight portions of the summation of the ultrahigh-molecular weight polyethylene and the polyethylene was added calcium carbonate (manufactured by Maruo Calcium Co. LTD.) with an average particle diameter of 0.1 μm and a BET specific surface area of 11.6 m²/g as the pore-forming agent so that its proportion to the entire volume is 36 vol %. These materials were mixed in a powder state in a Henschel mixer and then kneaded while melting in a twin-screw kneader to obtain a polyolefin-resin composite. The polyolefin-resin composite was rolled with a pair of rollers having a surface temperature of 150° C. to result in a sheet. The sheet was dipped in hydrochloric acid (4 mol/L) including 0.5 wt % of a nonionic surfactant to remove calcium carbonate, sequentially stretched to 6.2 times at a stretching rate of 1250% min at 100 to 105° C. to obtain a film with a thickness of 15.5 μm. A thermal fixation treatment was further performed at 120° C. to obtain the first layer 132. This first layer 132 was used as the separator 130.

### 1-2. Example 2

The separator 130 was obtained with the same method as the Example 1 except that 71% of the ultrahigh-molecular weight polyethylene power was used, 29% of the polyethylene wax was used, calcium carbonate (manufactured by Maruo Calcium Co. LTD.) with an average particle diameter of 0.1 μm and a BET specific surface area of 11.8 m²/g was used as the calcium carbonate, the polyolefin-resin composite was stretched at a stretching rate of 2100%/min, and the thermal fixation treatment was carried out at 123° C. The thickness of the separator 130 was 11.7 μm.

### 1-3. Example 3

The separator 130 was obtained with the same method as the Example 1 except that calcium carbonate (manufactured by Maruo Calcium Co. LTD.) with an average particle diameter of 0.1 μm and a BET specific surface area of 11.6 m²/g was used as the calcium carbonate, the polyolefin-resin composite was stretched at a stretching rate of 750%/min, and the thermal fixation treatment was carried out at 115° C. The thickness of the separator 130 was 16.3 μm.

An example for preparing separators used as Comparative Examples is described below.

### 1-4. Comparative Example 1

To a mixture of 71 wt % of ultrahigh-molecular weight polyethylene powder (GUR4032 manufactured by Ticona) and 29 wt % of polyethylene wax (FNP-0115 manufactured by Nippon Seiro Co. Ltd.) having a weight-average molecular weight of 1000 as well as 0.4 weight portions of an antioxidant (Irg1010 manufactured by CIBA Speciality Chemicals), 0.1 weight portions of an antioxidant (P168 manufactured by CIBA Speciality Chemicals), and 1.3 weight portions of sodium stearate with respect to 100 weight portions of the summation of the ultrahigh-molecular weight polyethylene and the polyethylene was added calcium carbonate (manufactured by Maruo Calcium Co. LTD.) with an average particle diameter of 0.1 μm and a BET specific surface area of 11.6 m²/g so that its proportion to the entire volume is 36 vol %. These materials were mixed in a powder state in a Henschel mixer and then kneaded while melting in a twin-screw kneader to obtain a polyolefin-resin composite. The polyolefin-resin composite was rolled with a pair of rollers having a surface temperature of 150° C. to result in a sheet. The sheet was dipped in hydrochloric acid (4 mol/L) including 0.5 wt % of a nonionic surfactant to remove calcium carbonate, sequentially stretched to 7.1 times at a stretching rate of 750% min at 100 to 105° C. to obtain a film with a thickness of 11.5 μm. A thermal fixation treatment was further performed at 120° C. to obtain the first layer 132.

### 1-5. Comparative Example 2

A commercially available polyolefin porous film (#2400 manufactured by Celgard, LLC.) was used as a comparative separator.

### 2. Fabrication of Secondary Battery

A method for fabricating the secondary batteries including the separators of the Examples 1 to 3 and Comparative Examples 1 and 2 is described below.

### 2-1. Positive Electrode

A commercially available positive electrode manufactured by applying a stack of LiNi_{0.5}Mn_{0.3}Co_{0.2}O₂/conductive material/PVDF (weight ratio of 92/5/3) on an aluminum foil was processed. Here, LiNi_{0.5}Mn_{0.3}Co_{0.2}O₂ is an active-substance layer. Specifically, the aluminum foil was cut so that a size of the positive-electrode active-substance layer is 45 mm×30 mm and that a portion with a width of 13 mm, in which the positive-electrode active-substance layer is not formed, was left in a periphery and was used as a positive electrode in the following fabrication process. A thickness, a density, and a positive-electrode capacity of the positive-electrode active-substance layer were 58 μm, 2.50 g/cm³, and 174 mAh/g, respectively.

### 2-2. Negative Electrode

A commercially available negative electrode manufactured by applying graphite/poly(styrene-co-1,3-butadiene)/carboxymethyl cellulose sodium salt (weight ratio of 98/1/1) on a copper foil was used. Here, the graphite functions as a negative-electrode active-substance layer. Specifically, the copper foil was cut so that a size of the negative-electrode active-substance layer is 50 mm×35 mm and that a portion with a width of 13 mm, in which the negative-electrode active-substance layer is not formed, was left in a periphery and was used as a negative electrode in the following fabrication process. A thickness, a density, and a negative-electrode capacity of the negative-electrode active-substance layer were 49 μm, 1.40 g/cm³, and 372 mAh/g, respectively.

### 2-3. Fabrication

The positive electrode, the separator, and the negative electrode were stacked in the order in a laminated pouch to obtain a stacked body. At this time, the positive electrode and the negative electrode were arranged so that the entire top surface of the positive-electrode active-substance layer overlaps with a main surface of the negative-electrode active-substance layer.

Next, the stacked body was arranged in an envelope-shaped housing formed by stacking an aluminum layer and a heat-seal layer, and 0.25 mL of an electrolyte solution was added into the housing. A mixed solution in which LiPF₆ was dissolved at 1.0 mol/L in a mixed solvent of ethyl methyl carbonate, diethyl carbonate, and ethylene carbonate with a volume ratio of 50:20:30 was used as the electrolyte solution. The secondary battery was fabricated by heat-sealing the housing while reducing the pressure in the housing. A designed capacity of the secondary battery was 20.5 mAh.

### 3. Evaluation

A variety of physical properties of the separators of the Examples 1 to 3 and the Comparative Examples 1 and 2 and the evaluation results of the performance of the secondary batteries including the separators are described below.

### 3-1. Thickness

The thicknesses were measured using a High-Resolution Digital Measuring Unit manufactured by Mitsutoyo Corporation.

### 3-2. Temperature-Increase Convergence Time

After dipping the separator with a size of 8 cm×8 cm into a N-methylpyrrolidone to which 3 wt % of water was added, the separator was spread over a sheet of Teflon™ (size: 12 cm×12 cm) and then folded in half to sandwich an optical fiber thermometer (Neoptix Reflex thermometer manufactured by ASTECH corporation.) wrapped with polytetrafluoroethylene.

Next, after the separator sandwiching the thermometer was fixed in a microwave-irradiation apparatus (9 kW microwave oven with a frequency of 2455 Hz, manufactured by Micro Denshi Co. Ltd.) equipped with a turning table, a microwave was applied at 1800 W for 2 minutes.

The temperature variation of the separator after starting the microwave irradiation was measured every 0.2 second using the aforementioned optical fiber thermometer. In this temperature measurement, the temperature at which no temperature increase was observed for 1 second or more was employed as the temperature-increase convergence temperature, and the time from starting the microwave irradiation until reaching the temperature-increase convergence temperature was used as a convergence time. The temperature-increase convergence time was calculated by dividing the convergence time by the weight per unit area of the separator.

3-3. Rate Property after Charging/Discharging Cycle

The secondary battery 100 fabricated with the method described above was subjected to a four-cycle initial charging/discharging where one cycle is performed with a current of 0.2 C in a voltage range from 4.1 V to 2.7 V at 25° C.

The secondary batteries which was subjected to the initial charging/discharging was further subjected to three cycles of charging and discharging at a constant current with a charging current of 1 C and discharging currents of 0.2 C and 20 C at 55° C. After that, the secondary batteries were subjected to 100-cycle charging/discharging where one cycle was performed at a constant current with a charging current of 1 C and a discharging current of 10 C in a voltage range from 4.2 V to 2.7 V at 55° C. After that, three cycles of charging and discharging were carried out at a constant current with a charging current of 1 C and discharging currents of 0.2 C and 20 C at 55° C. A ratio of the discharge capacitances between at the discharge currents of 0.2 C and 20 C (20 C discharge capacitance/0.2 C discharge capacitance) in the third cycle were obtained as a rate property after the 100-cycle charging/discharging (a rate property after 100 cycles).

### 3-4. WI

The WIs of the separators were measured with a SCI (Specular Component Include (including regular reflection light)) method using a spectrophotometer (CM-2002 manufactured by Minolta Co., LTD) in a state where the separator was arranged over a black paper (a thickest black-colored grain long fine paper with a size of 788 mm×1091 mm). An average of the measured values obtained at three or more positions was employed as a result.

The properties of the separators of the Examples 1 to 3 and the Comparative Examples 1 and 2 as well as those of the secondary batteries fabricated using the separators are summarized in Table 1. As shown in Table 1, it was proven that the secondary batteries including the separator 130 having the temperature-increase convergence time equal to or longer than 2.9 s·m²/g and equal to or shorter than 5.7 s·m²/g and the WI equal to or more than 85 and equal to or less than 98 is capable of exhibiting an excellent rate property even after charging/discharging is repeated. On the other hand, it was found that the rate property of the secondary batteries using the separators of the Comparative Examples 1 and 2 which do not satisfy the aforementioned properties significantly decreases after repeating charging/discharging.

TABLE 1
Properties of the separators and secondary batteries

| | Temperature-increase | | Rate property |
|---|---|---|---|
| | terminating time/ | | after 100-cycle |
| | base weight | | charging/discharging |
| | (s · m²/g) | WI | (%) |
| Example 1 | 2.9 | 94.40 | 52 |
| Example 2 | 5.2 | 91.56 | 56 |
| Example 3 | 5.6 | 96.76 | 49 |
| Comparative | 2.8 | 85.74 | 13 |
| Example 1 | | | |
| Comparative | 1.9 | 83.47 | 36 |
| Example 2 | | | |

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements is included in the scope of the present invention as long as it possesses the concept of the present invention.

It is understood that another effect different from that provided by the modes of the aforementioned embodiments is achieved by the present invention if the effect is obvious from the description in the specification or readily conceived by persons ordinarily skilled in the art.

### EXPLANATION OF REFERENCE NUMERAL

100: Secondary battery, 110: Positive electrode, 112: Positive-electrode current collector, 114: Positive-electrode active-substance layer, 120: Negative electrode, 122: Negative-electrode current collector, 124: Negative-electrode active-substance layer, 130: Separator, 132: First layer, 134: Porous layer, 140: Electrolyte solution

1. A separator comprising:
a first layer consisting of a porous polyolefin, having a temperature-increase convergence time equal to or longer than 2.9 s·m²/g and equal to or shorter than 5.7 s·m²/g when the first layer is irradiated with a microwave having a frequency of 2455 MHz and an output power of 1800 W after dipping the first layer in N-methylpyrrolidone containing 3 wt % of water, and having a white index equal to or more than 86 and equal to or less than 98.

2. The separator according to claim 1,
wherein the temperature-increase convergence time is equal to or longer than 2.9 s·m²/g and equal to or shorter than 5.3 s·m²/g.

3. The separator according to claim 1,
wherein the white index is equal to or more than 90 and equal to or less than 97.

4. The separator according to claim 1, further comprising a porous layer over the first layer.

5. The separator according to claim 1, further comprising a pair of porous layers sandwiching the first layer.

6. A secondary battery comprising the separator according to claim 1.
